(19) United States
(12) Patent Application Publication
(10) Pub. No.: US 2007/0026736 A1
(43) Pub. Date: Feb. 1, 2007

(54) CONNECTOR ISOLATION SHIELDING SYSTEM AND METHOD

(75) Inventors: Michael Itano, Seattle, WA (US); Frank Chin-Hwan Kim, Woodinville, WA (US); John Redfield, Brier, WA (US); Jeffrey P. Seefried, Lake Stevens, WA (US)

Correspondence Address: DAVIS WRIGHT TREMAINE, LLP, 2600 CENTURY SQUARE, 1501 FOURTH AVENUE, SEATTLE, WA, 98101-1688, US

(73) Assignee: LEVITON MANUFACTURING CO., INC., Little Neck, NY (US)

(21) Appl. No.: 11/424,219

(22) Filed: Jun. 14, 2006

Related U.S. Application Data
(60) Provisional application No. 60/690,821, filed on Jun. 14, 2005.

(51) Int. Cl. H01R 13/648

(52) U.S. Cl. 439/607

(57) ABSTRACT

Implementations of a shielded connector system involve connector isolation shielding using shield enclosures to reduce crosstalk and noise transmitted between adjacent signal cable connectors. These implementations allow for manufacture of new equipment and also retrofitting of existing equipment for connector isolation shielding using standard connector configurations without specialized labor intensive terminations for cable and for connectors required of conventional approaches.

### CROSS REFERENCE TO RELATED APPLICATION

This application claims priority benefit of provisional application Ser. No. 60/690,821 filed Jun. 14, 2005.

### BACKGROUND OF THE INVENTION

1. Field of the Invention

The present invention is generally related to communication stations and associated signal cable connectors.

2. Description of the Related Art

With increases in data rates, such as including data rates of 10 gigabits over copper base cable, isolation of external cross-talk and noise between adjacent signal cable connectors (jacks), in addition to the customary isolation of internal cross-talk and noise between signal pairs within a connector, has become a focus of concern. When internal crosstalk and noise within individual connectors and external crosstalk and noise transmitted between connectors are reduced, signal quality can be enhanced and data rates can be increased. With the advent of new cable designs that isolate external crosstalk and noise between cabling systems, it has become even more desirable to reduce external crosstalk and noise between connectors as well.

Conventional approaches to reduce external crosstalk and noise between connectors have used shielded connectors such as for specialized secure communication. Unfortunately, conventional shielded connectors require terminations for cable and for connectors that are labor intensive to implement.

### BRIEF DESCRIPTION OF THE SEVERAL VIEWS OF THE DRAWING(S)

FIG. 1 is an exploded front perspective view of a first implementation of a shielded connector system.

FIG. 2 is a front perspective view of the first implementation of the shielded connector system of FIG. 1.

FIG. 3 is an exploded rear perspective view of the shielded connector system of FIG. 1.

FIG. 4 is a rear perspective view of the shielded connector system of FIG. 1.

FIG. 5 is a front elevational view of a communication station containing the shielded connector system of FIG. 1.

FIG. 6 is an exploded front perspective view of a second implementation of a shielded connector system.

FIG. 7 is a front perspective view of the second implementation of the shielded connector system of FIG. 6.

FIG. 8 is an exploded rear perspective view of the shielded connector system of FIG. 6.

FIG. 9 is a rear perspective view of the shielded connector system of FIG. 6.

FIG. 10 is a front elevational view of a communication station containing the shielded connector system of FIG. 6.

FIG. 11 is a front elevational view of a communication station containing the shielded connector system of FIG. 1 for other implementations of connectors.

FIG. 12 is a front elevational view of a communication station containing the shielded connector system of FIG. 6 for other implementations of connectors.

### DETAILED DESCRIPTION OF THE INVENTION

As discussed herein implementations of a shielded connector system involve connector isolation shielding using shield enclosures to reduce crosstalk and noise transmitted between adjacent signal cable connectors. These implementations allow for manufacture of new equipment and also retrofitting of existing equipment for connector isolation shielding using standard configurations of connectors without specialized labor intensive terminations for the cable and for the connectors is required of conventional approaches.

Shield enclosure implementations may be fabricated to include either a sheet metal part, a cast part, or an injection molded part. Some shield enclosure implementations only have one of its walls providing a majority of shielding for a pair of connectors positioned on either side of the wall at times when casting or injection molding is used to form the shield enclosure implementation. On the other hand, shield enclosure implementations as stamped parts can have walls as little as 0.008 inches thick allowing for more than one wall to provide shielding. Regarding injection molded implementations, shielding can be enhanced by a foil shield that is placed on the side of a connector that is not covered by the injection molded shield enclosure.

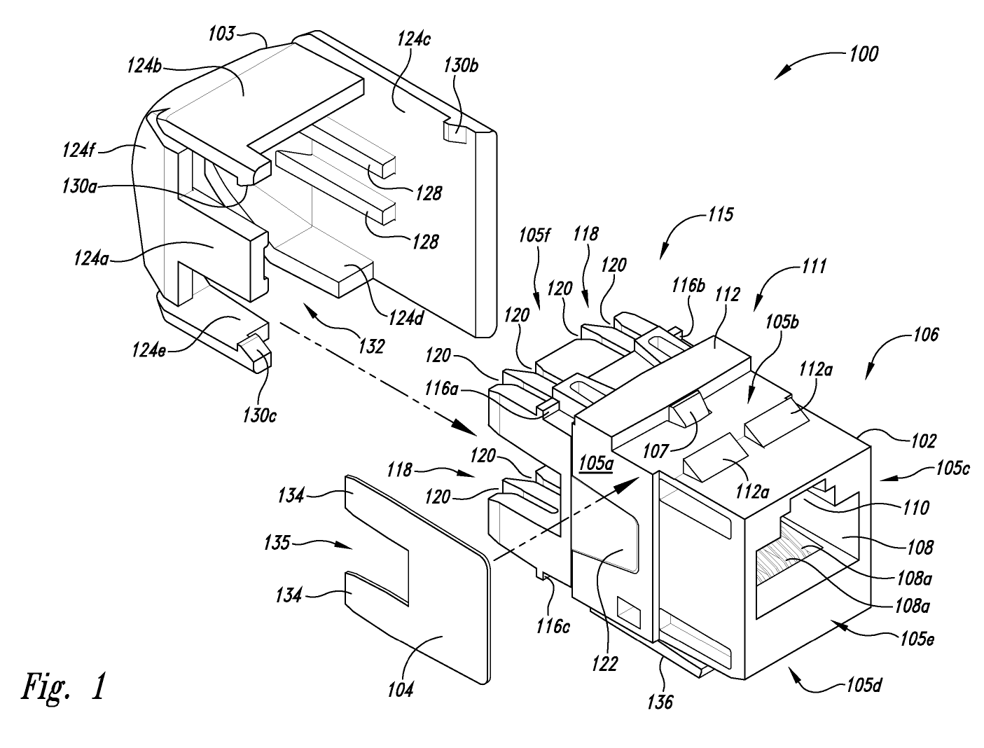

A first implementation 100 of the shielded connector system is shown in FIG. 1 as having a connector 102, a shield enclosure 103, and a shield sheet 104. Implementations of the shield enclosure 103 can be cast or injection molded. The shield enclosure 103 can have a matrix of ABS plastic with 10% stainless steel fibers to shield noise and crosstalk. As shown, the shield enclosure 103 is shaped to cover portions of the connector 102. The shield sheet 104 can be laminated with a signal deterring material such as an electrically conductive material like aluminum foil. The shield sheet can be glued, otherwise adhered, or otherwise affixed to the connector 102. As further shown, the relative thinness of the shield sheet 104 allows the shield enclosure 103 to be relatively thick with its material, such as the ABS-stainless steel composite, being fully used on one side of the connector 102. In some implementations the relative greater thickness of the shield enclosure 103 may also more readily allow for manufacture of the shield enclosure.

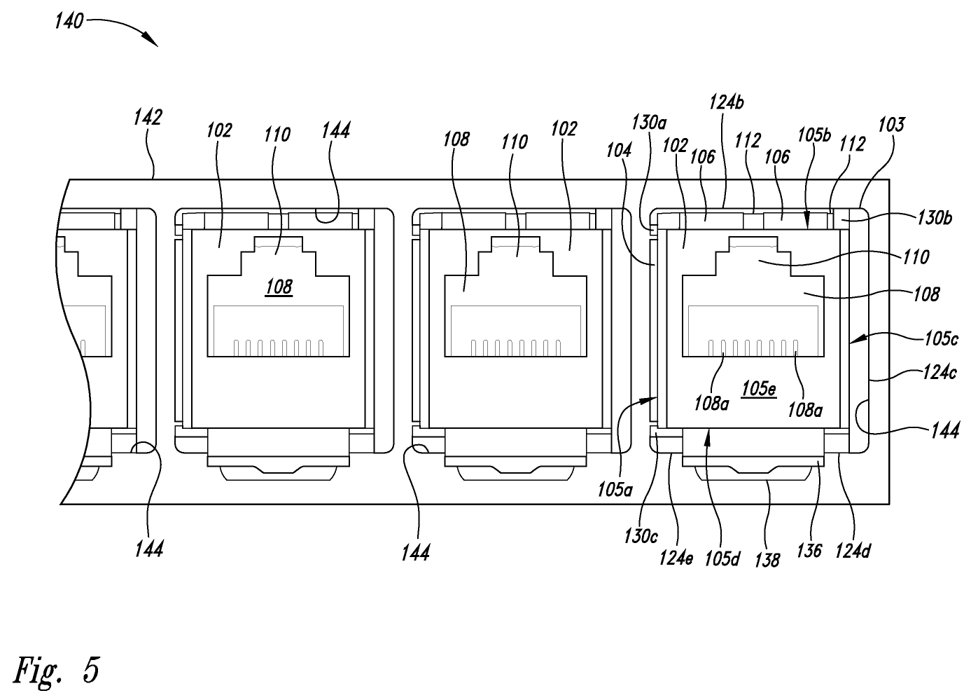

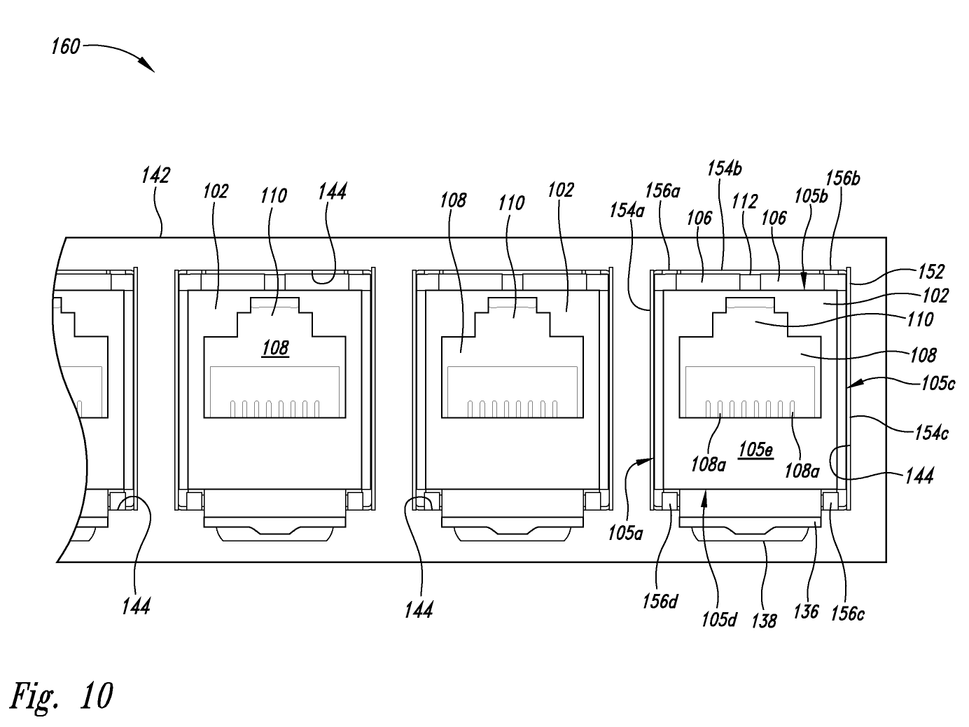

The connector 102 includes a first face 105a, a second face 105b, a third face 105c, a fourth face 105d, a front face 105e, and a rear face 105f. The connector 102 has a front section 106 with beveled tabs 106a extending therefrom on the second face 105b to assist in part for engagement with a connector port of a stand-alone or rack mounted station (see examples below regarding FIG. 5 and FIG. 10). The front section 106 has a plug receiving portion 108 with contacts 108a positioned to couple with contacts of a conventional communication plug (not shown) generally coupled to a conventional signal cable (not shown) received through the front face 105e. The plug receiving portion 108 has a plug engagement notch 110 for engagement with the conventional communication plug (not shown). As shown, the plug engagement notch 110 is adjacent the second face 105b. A mid-section 111 extends rearward from the front section 106 toward the rear face 105f of the connector 102. The mid-section 111 includes a spacer 112 and a beveled tab 112a that extend from the second face 105b of the connector 102. A rear section 115 extends rearward from the mid-section 111 to include the rear face 105f. The rear section 115 includes a first tab 116a and a second tab 116b that extend from the second face 105b of the connector 102. A third tab 116c and a fourth tab 116d extend from the fourth face 105d on the connector 102. Wire receivers 118 (such as insulation displacement contacts—IDCs) are positioned along the rear face 105f, each with a correspondingly positioned wire slot 120 to receive a wire (not shown) for electrical connection of the wires to the wire receivers, which are electrically connected to contacts 108a of the plug receiving portion 108. A notch portion 122 is located along the first face 105a of the connector 102.

The shield enclosure 103 includes a first wall 124a, a second wall 124b, a third wall 124c, a first portion of a fourth wall 124d, a second portion of the fourth wall 124e, and a rear wall 124f. The shield enclosure 103 has engagement portions including a first beveled tab 130a, a second beveled tab 130b, and a third beveled tab 130c. The engagement portions allow the shield enclosure 103 to be coupled with the connector 102 by a snap fit engagement. The first beveled tab 130a extends from the second wall 124b. The second beveled tab 130b extends from the third wall 124c. The third beveled tab 130c extends from the second portion of the fourth wall 124e. When the shield enclosure 103 engages with the connector 102, the first beveled tab 130a of the shield enclosure engages with the first tab 116a of the connector 102, the second beveled tab 130b of the shield enclosure engages with a forward face of the spacer 112 of the connector, and the third beveled tab 130c engages with the third tab 116c. Other implementations use other types of engagement portions of snap fit engagement or other removably engagement of the shield enclosure 103 with the connector 102. The first portion of the fourth wall 124d and the second portion of the fourth wall 124e are spaced apart to form a slot 132 used in part for access to wire that is coupled with the wire pair receivers 118. In some implementations the slot 132 may allow the shield enclosure 103 to be snapped onto the connector 102 while wires (not shown) are coupled to the wire receivers 118. Spacers 128 extend from the third wall 124c to assist in positioning of the shield enclosure 103 when engaged with the connector 102.

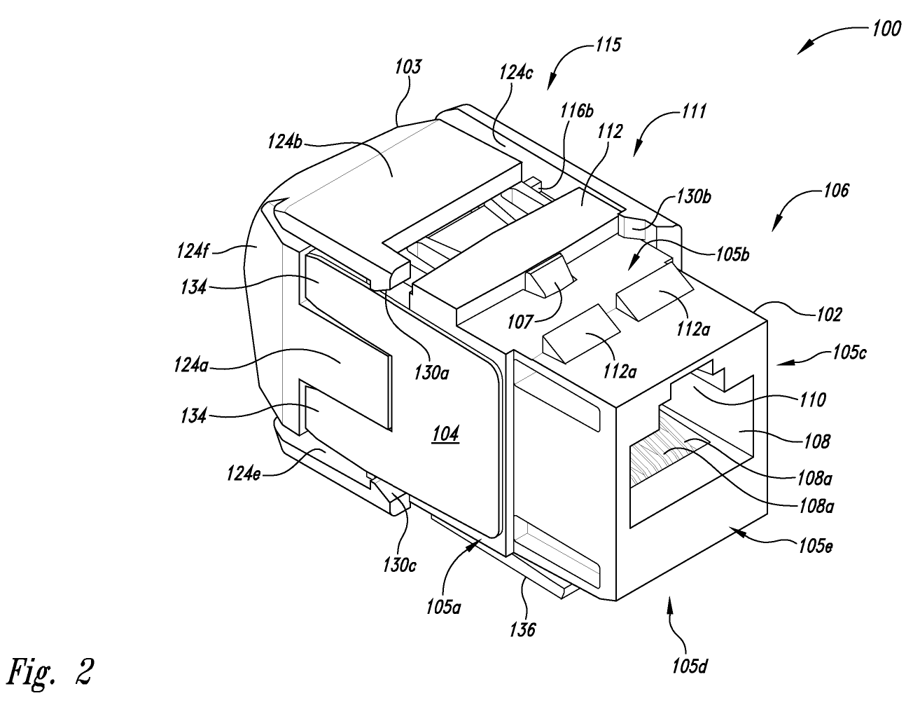

The shield sheet 104 includes two rearwardly extended portions 134 spaced apart to form a slot 135 therebetween. As shown in FIG. 2, the slot 135 is sized to receive the first wall 124a to allow for substantially continuation coverage along the first face 105a of the mid-section 111 and the rear section 115 when shield enclosure 103 and the shield sheet 114 are engaged and/or affixed to the connector 102.

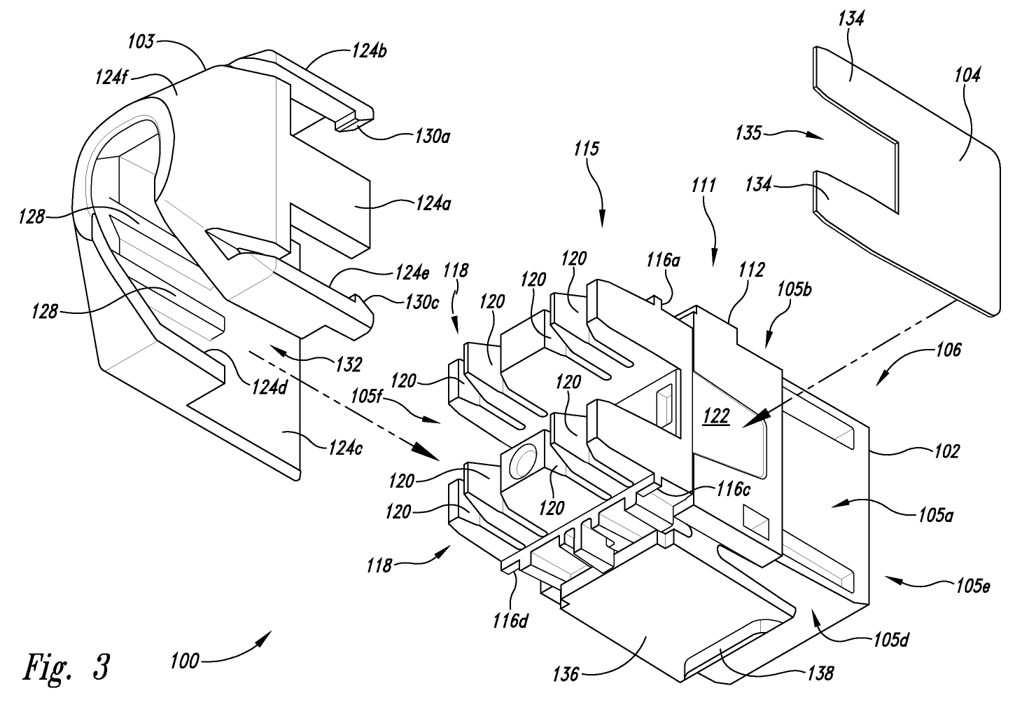

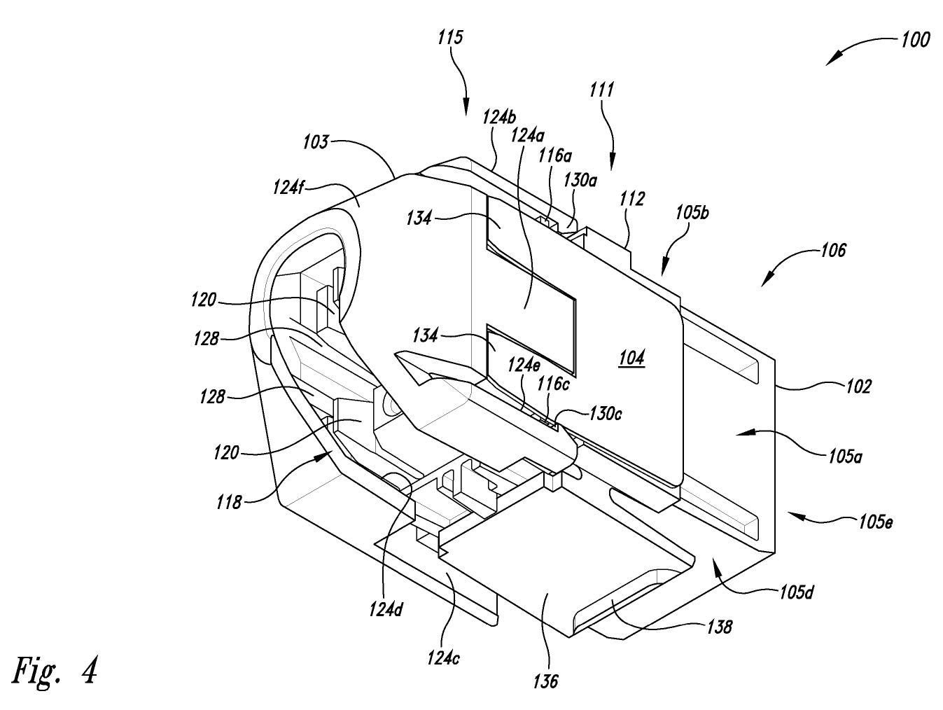

As shown in FIG. 3 and FIG. 4, a hinged member 136 extends from the fourth face 105d of the connector 102. The hinged member 136 includes a beveled tab 138 for engagement with a port such as of a station 140 shown in FIG. 5. The station 140 includes a mounting frame 142 having ports 144 into which the connectors 102 are inserted. The connectors 102 are each inserted with its own shield enclosure 103 and its own shield sheet 104. The connectors 102 are arranged in the station 140 such that for each pair of adjacent connectors, the shield sheet 104 and the first wall 124a of the shield enclosure 103 of the first connector of the pair and the third wall 124c of the shield enclosure of the second connector of the pair are positioned between the adjacent connectors.

Consequently, between each of the adjacent pairs of the connectors 102, one of the third walls 124c is position therebetween to perform a substantial amount of shielding of crosstalk and noise that could otherwise occur between the adjacent connectors of the pair. The respective shield sheet 104 and the respective first wall 124a positioned between the pair adjacent connectors also contribute in reducing crosstalk and noise being transferred between adjacent connectors. The overall combined effect in reducing crosstalk and noise from being transferred between adjacent pairs of the connectors 102 can thus be sizeable.

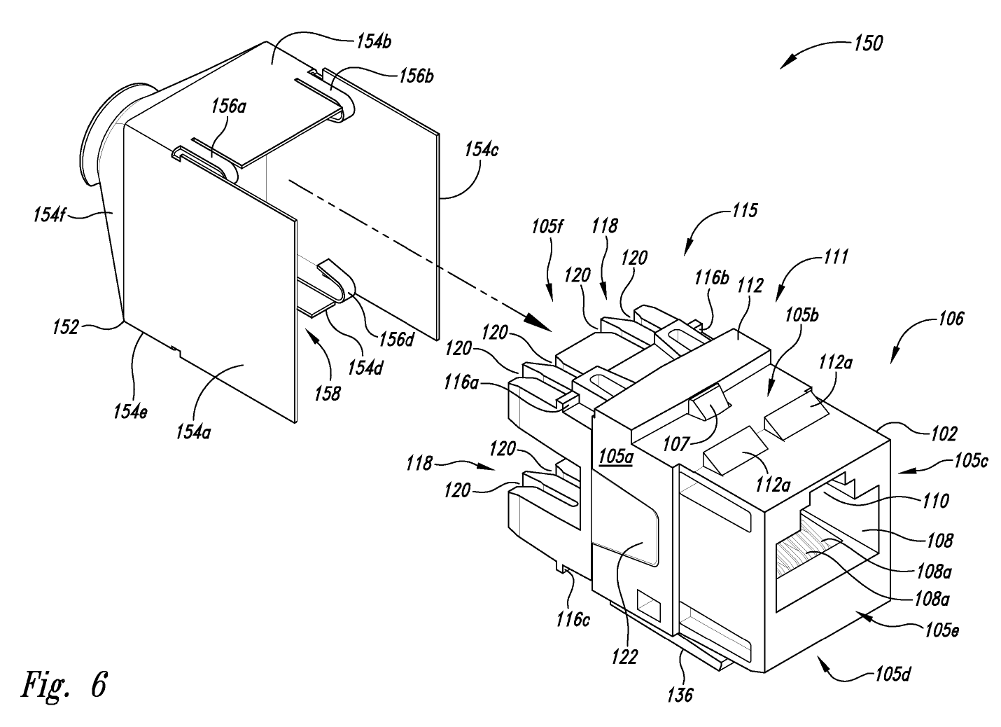

A second implementation 150 of the shielded connector system is shown in FIGS. 6-9 as having the connector 102 and a shielded enclosure 152. Implementations of the shielded enclosed 152 can be made by a stamping process such as stamping of sheet metal.

The shielded enclosure has a first wall 154a, a second wall 154b, a third wall 154c, a first portion of a fourth wall 154d, a second portion of a fourth wall 154e, and a rear wall 154f. Extending from the second wall 154b is a first catch 156a and a second catch 156b. Extending from the second portion of the fourth wall 154e is a third catch 156c and extending from the first portion of the fourth wall 154d is a fourth catch 156d.

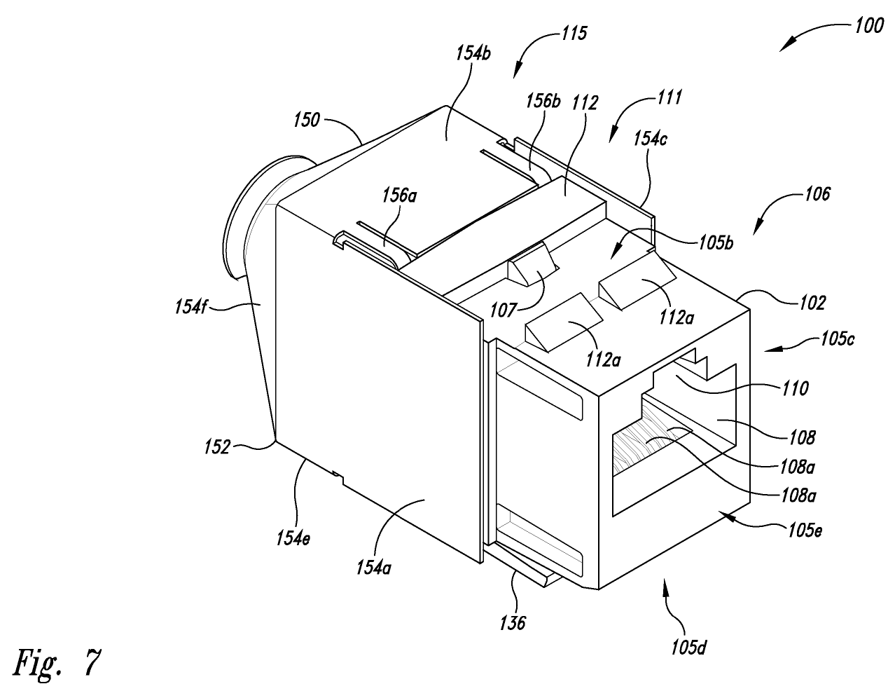

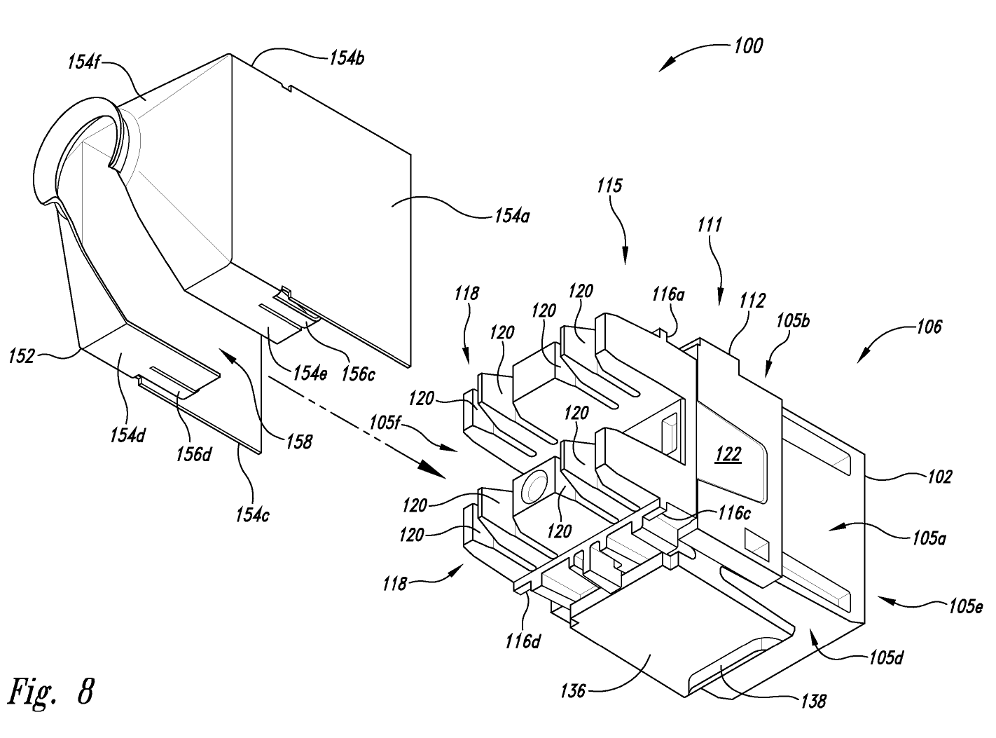

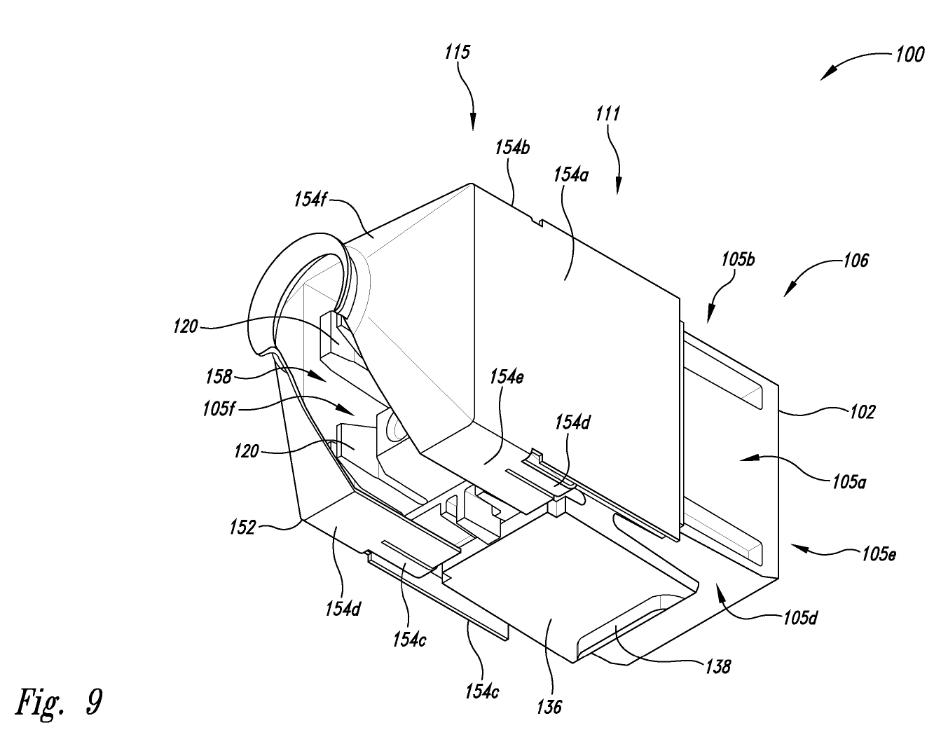

When the shielded enclosure 152 is engaged with the connector 102, as shown in FIG. 7, the first catch 156a of the shielded enclosure engages with the first tab 116a of the connector, the second catch 156b of the shielded enclosure engages with the second tab 116b of the connector, the third catch 156c of the shielded enclosure engages with the third tab 116c of the connector, and the fourth catch 156d of the shield enclosure engages with the fourth tab 116d of the connector (better shown in FIG. 8 and FIG. 9). The first portion of the fourth wall 154d and the second portion of fourth wall 154e are spaced apart to form a slot 158 therebetween to allow for access to the wire pair receivers 118 when the shielded enclosure 152 is engage with the connector 102 as shown in FIG. 9. As shown in FIG. 10, a station 160 includes the mounting frame 142 with the ports 144 each receiving one of the connectors 102 and an associated one of the shielded enclosures 152.

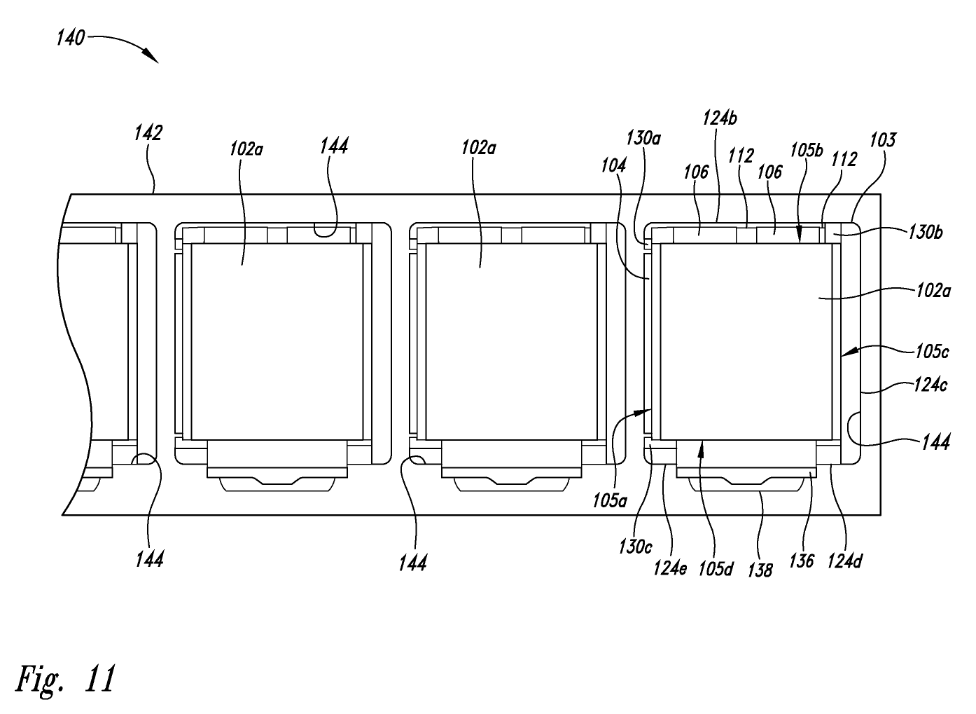

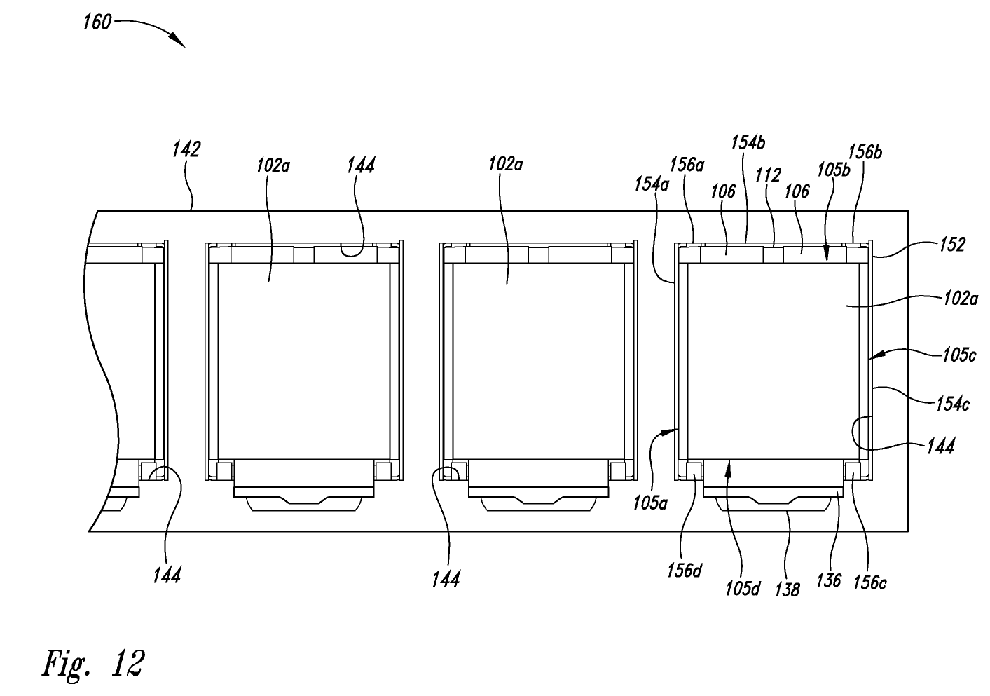

Although, the connector 102 was depicted in FIGS. 1-10 as a standard conventional RJ-11 connector, other types of connectors 102a could be used with various other implementations of the shield enclosure 103, shown in FIG. 11, and the shield enclosure 152, shown in FIG. 12. These other types of connectors 102a can include such standard conventional types of connectors as RJ-45, S-Video, 10G, Cat 6, Cat 6+, RCA, or other standard conventional types of connectors. The connectors 102 and the connectors 102a can include such style as conventional QuickPort and Keystone snap-in type connectors.

From the foregoing it will be appreciated that, although specific embodiments of the invention have been described herein for purposes of illustration, various modifications may be made without deviating from the spirit and scope of the invention. For instance, a shield enclosure implementation could be molded with a conductive plastic interior and a resistive outer skin. Other shield enclosure implementations could include stainless steel fiber filled polycarbonate and/or nylon. Some shield enclosure implementations could use a 10% composition of stainless steel. Still other shield enclosure implementations could include polyphenyline sulfide or other material filled with carbon fiber (such as at a 40% composition level). Other shield enclosure implementations could use materials including aluminum flake filled plastics or nickel coated graphite fiber filled plastics.

As depicted in FIG. 2 and FIG. 4, the first wall 124a and the shield sheet 104 of the shield enclosure 103 combine to extend from the rear face 105f substantially along the first face 105a of the rear section 115 and the mid-section 111 up to the front section 106 of the connector 102. The third wall 124c of the shield enclosure 103 extends from the rear face 105f substantially along the third face 105c of the rear section 115 and the mid-section 111 up to the front section 106 of the connector 102. In other implementations, the combination of the shield sheet 104 and the first wall 124a and/or the third wall 124c of the shield enclosure 103 may extend to a different degree as that depicted. For instance, they may extend along the rear section 115 up to the mid-section 111 or partial along the mid-section, but not entirely up to the front section 106. Alternatively, they may extend further to cover a portion of the first face 105a and the third face 105c, respectively, of the front section 106 of the connector 102, however, clearances between the front section and port walls (not shown) may prohibit this to a certain degree. Furthermore, the connector 102 could have only the rear section 115 and the front section 106 without the mid-section 111 so that the combination of the shield sheet 104 and the first wall 124a and/or the third wall 124c of the shield enclosure 103 could be sized differently to provide further coverage of the rear section 115.

As depicted in FIG. 7 and FIG. 9, the first wall 154a of the shield enclosure 152 extends from the rear face 105f substantially along the first face 105a of the rear section 115 and the mid-section 111 up to the front section 106 of the connector 102. The third wall 154c of the shield enclosure 152 extends from the rear face 105f substantially along the third face 105c of the rear section 115 and the mid-section 111 up to the front section 106 of the connector 102. In other implementations, the first wall 154a and/or the third wall 154c of the shield enclosure 152 may extend to a different degree as that depicted. For instance, they may extend along the rear section 115 up to the mid-section 111 or partial along the mid-section, but not entirely up to the front section 106. Alternatively, they may extend further to cover a portion of the first face 105a and the third face 105c, respectively, of the front section 106 of the connector 102, however, clearances between the front section and port walls may prohibit this to a certain degree. Furthermore, the connector 102 could have only the rear section 115 and the front section 106 without the mid-section 111 so that the first wall 154a and/or the third wall 154c of the shield enclosure 152 could be sized differently to provide further coverage of the rear section 115.

As depicted the second wall 124b, the first portion of the fourth wall 124d, and the second portion of the fourth wall 124e of the shield enclosure 103 extend forwardly from the rear face 105f a majority of the rear section 115 of the connector 102. The second wall 154b, the first portion of the fourth wall 124d, and the second portion of the fourth wall 124e of the shield enclosure 152 extended substantially forwardly from the rear face 105f a majority of the rear section 115 of the connector 102. In other implementations, the degree to which these various walls extend could also differ to cover amounts of the rear section 115 different than depicted. In other implementations, the connector 102 could have only the rear section 115 and the front section 106 without the mid-section 111 so that these various walls could be sized differently to provide further coverage of the rear section 115.

As further examples, other shielded enclosure implementations use various materials including but not limited to cartridge brass, phosphor bronze, stainless steel, nickel silver, and nickel bronze in sheet metal. Other shielded enclosure implementations can use injection molded parts with associated resin being impregnated with conductive material. In some shielded enclosure implementations using stamped metal, an insulator can be placed on the inside of the stamped metal to prevent accidental contact of associated terminated wires. However in other shielded enclosure implementations, stamped metal can be located sufficiently far from terminated wires so that such an insulator may not be necessary. Accordingly, the invention is not limited except as by the appended claims.

The invention claimed is:

1. A system for a connector, the connector having a front face and a rear face with a first face, a second face, a third face and a fourth face extending therebetween, the first face being substantially perpendicular to the second face and the fourth face and extending therebetween, the third face being substantially perpendicular to the second face and the fourth face and extending therebetween, the connector having a front section with the front face and a rear section with the rear face, the front section having a plug receiving portion along the front face to receive a communication plug, the plug receiving portion having a plug engagement notch substantially adjacent a portion of the second face, the rear section having wire receivers each with a wire slot to receive a wire, the system comprising:
a shield enclosure having a first wall, the first wall configured to couple to the connector, when coupled to the connector, the first wall sized to substantially cover a portion of the third face of the connector extending forwardly from the rear face of the connector toward the front face of the connector along substantially the entire rear section of the connector, the first wall configured to substantially reduce crosstalk from passing through the first wall.

2. The system of claim 1 wherein the shield enclosure further includes engagement portions to provide snap on type engagement of the shield enclosure with the connector.

3. The system of claim 1 wherein the first wall extends substantially to the front section of the connector.

4. For the connector, wherein the connector further has a mid-section between the rear section and the front section, the system of claim 3 wherein the first wall substantially covers the third face portion of the mid-section when the first wall is coupled to the connector.

5. The system of claim 1 further comprising a rear wall extending from the first wall, the rear wall sized and positioned to cover a portion of the rear face of the connector along a portion of the rear section when the shield enclosure is coupled to the enclosure, the rear wall configured to substantially reduce crosstalk from passing through the rear wall.

6. The system of claim 5 further comprising a second wall extending from the rear wall, the second wall sized to partially cover a portion of the first face of the connector extending forwardly from the rear face of the connector toward the front face of the connector partially along the rear section of the connector, the second wall configured to substantially reduce crosstalk from passing through the second wall.

7. The system of claim 6 further comprising a shield sheet sized to cover some portions of the first face of the connector not covered by the second wall when the shield sheet and the second wall are engaged with the connector, the shield sheet configured to substantially reduce crosstalk from passing through the shield sheet.

8. The system of claim 7 wherein the shield sheet has a first extended portion and a second extended portion spaced therefrom to form a slot, the slot sized and rearwardly facing to receive the second wall when the second wall and the shield sheet are engaged with the connector.

9. The system of claim 7 wherein the shield sheet is made from foil.

10. The system of claim 6 further comprising a third wall extending from the rear wall, the third wall sized to partially cover a portion of the second face of the connector extending forwardly from the rear face of the connector toward the front face of the connector partially along the rear section of the connector, the third wall configured to substantially reduce crosstalk from passing through the third wall.

11. The system of claim 6 further comprising a fourth wall extending from the rear wall, the fourth wall sized to partially cover a portion of the fourth face of the connector extending forwardly from the rear face of the connector toward the front face of the connector partially along the rear section of the connector, the fourth wall configured to substantially reduce crosstalk from passing through the fourth wall.

12. The system of claim 11 wherein the fourth wall has a first portion and a second portion spaced apart therefrom to form a slot, the slot extending partially into the rear wall to allow for at least one of the following: access to the wire receivers of the connector and capability to engage the shield enclosure with the connector while one or more wires are engaged with the wire receivers of the connector.

13. The system of claim 5 further comprising a second wall extending from the rear wall, the second wall sized to substantially cover a portion of the first face of the connector extending forwardly from the rear face of the connector toward the front face of the connector partially along the rear section of the connector substantially up to the front section, the second wall configured to substantially reduce crosstalk from passing through the second wall.

14. The system of claim 13 further comprising a third wall extending from the rear wall, the third wall sized to partially cover a portion of the second face of the connector extending forwardly from the rear face of the connector toward the front face of the connector partially along the rear section of the connector, the third wall configured to substantially reduce crosstalk from passing through the third wall.

15. The system of claim 14 further comprising a fourth wall extending from the rear wall, the fourth wall sized to partially cover a portion of the fourth face of the connector extending forwardly from the rear face of the connector toward the front face of the connector partially along the rear section of the connector, the fourth wall configured to substantially reduce crosstalk from passing through the fourth wall.

16. The system of claim 15 wherein the fourth wall has a first portion and a second portion spaced apart therefrom to form a slot, the slot extending partially into the rear wall to allow for at least one of the following: access to the wire receivers of the connector and capability to engage the shield enclosure with the connector while one or more wires are engaged with the wire receivers of the connector.

17. A system comprising:
a connector, the connector having a front face and a rear face with a first face, a second face, a third face and a fourth face extending therebetween, the first face being substantially perpendicular to the second face and the fourth face and extending therebetween, the third face being substantially perpendicular to the second face and the fourth face and extending therebetween, the connector having a front section with the front face and a rear section with the rear face, the front section having a plug receiving portion along the front face to receive a communication plug, the plug receiving portion having a plug engagement notch substantially adjacent a portion of the second face, the rear section having wire receivers each with a wire slot to receive a wire; and
a shield enclosure having a first wall, the first wall configured to couple to the connector, when coupled to the connector, the first wall sized to substantially cover a portion of the third face of the connector extending forwardly from the rear face of the connector toward the front face of the connector along substantially the entire rear section of the connector, the first wall configured to substantially reduce crosstalk from passing through the first wall.

18. The system of claim 17 wherein the shield enclosure further includes engagement portions to provide snap on type engagement of the shield enclosure with the connector.

19. The system of claim 17 wherein the first wall extends substantially to the front section of the connector.

20. A system for a connector, the connector being a standard connector having one of the following types: RJ-11, RJ-45, S-Video, 10G, Cat 6, Cat 6+, and RCA, the connector having a front face and a rear face with a first face, a second face, a third face and a fourth face extending therebetween, the first face being substantially perpendicular to the second face and the fourth face and extending therebetween, the third face being substantially perpendicular to the second face and the fourth face and extending therebetween, the connector having a front section with the front face and a rear section with the rear face, the front section having a plug receiving portion along the front face to receive a communication plug, the plug receiving portion having a plug engagement notch substantially adjacent a portion of the second face, the rear section having wire receivers each with a wire slot to receive a wire, the system comprising:
a shield enclosure having a first wall, the first wall configured to couple to the connector, when coupled to the connector, the first wall sized to substantially cover a portion of the third face of the connector extending forwardly from the rear face of the connector toward the front face of the connector along substantially the entire rear section of the connector, the first wall configured to substantially reduce crosstalk from passing through the first wall.

21. The system of claim 20 wherein the shield enclosure further includes engagement portions to provide snap on type engagement of the shield enclosure with the connector.

22. The system of claim 21 wherein the first wall extends substantially to the front section of the connector.
